(19) United States
(12) Patent Application Publication
(10) Pub. No.: US 2005/0112368 A1
(43) Pub. Date: May 26, 2005

(54) Biaxially oriented polypropylene-based adhesive tape film backings

(75) Inventors: Kevin M. Hamer, St. Paul, MN (US); Patrick J. Hager, Woodbury, MN (US); John M. Klaeser, Greenville, SC (US); Randall E. Kozulla, Stillwater, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/978,849

(22) Filed: Nov. 1, 2004

Related U.S. Application Data
(60) Provisional application No. 60/524,575, filed on Nov. 24, 2003.

(51) Int. Cl. B32B 27/08; B32B 33/00

(52) U.S. Cl. 428/343; 428/220

(57) ABSTRACT

A simultaneously biaxially oriented polypropylene film is formed from a propylene containing polymer resin. The film has a machine direction and a transverse direction. The oriented film has a tensile strength in the machine direction of at least 190 N/mm², and a normalized haze value of less than or equal to 8%/mm.

### CROSS-REFERENCE TO RELATED APPLICATION(S)

This application claims priority from U.S. Provisional Patent Application No. 60/524,575, filed on Nov. 24, 2003.

### BACKGROUND OF THE INVENTION

The present invention relates to films useful as tape backings, and more particularly to simultaneously biaxially stretched polypropylene films having certain desired tensile strength and haze values.

Commercially available pressure sensitive tapes are usually provided in a pad or roll form. In some applications, it is desirable for the tape to be as clear as possible (i.e., transparent) while also possessing other useful properties such as a high tensile strength in a tape longitudinal direction. For example, such tape qualities may be desirable in box sealing or packaging tape products.

A typical backing for packaging tape is polypropylene film. The predominant supply of this kind of film is a biaxially oriented backing from a film tenter line in order to control caliper or gauge profile so that the film backing can be uniformly coated with adhesive. When clear adhesives are used, the film backing must also be clear so that the resultant rolls of tape from such components are aesthetically pleasing. In a typical tape configuration, the film backing has a layer of adhesive on one side, and a layer of release coat material on the other side so that when placed in roll form for tape dispensing, the separation of one layer from the rest of the roll is facilitated.

Typically, however, film strengths in the tape direction (the tape longitudinal direction) in common packaging tapes do not exceed about 180 N/mm², in the case of tapes that use an industry standard of 0.050 mm thickness for the film backing of typically competitive packaging, mailing and box sealing tapes. The tape's tensile strength is primarily due to the film backing of the tape. While strength may be enhanced by using thicker film backings, the level of film stiffness then increases and the tape, at some point, fails to conform well to the packages to which it is applied. Moreover, using thicker film backings makes such tape proportionately more costly.

A high degree of clarity is also very desirable in such tapes. It has become common to place information on an outer surface of a tape roll core, which can then be viewed through the roll of transparent tape that is wound on that core. Such information may identify the type of tape, or constitute advertising material or merely decorative indicia. Simultaneously biaxially oriented polypropylene film backings have been made which provide relatively high strength (i.e., tensile break stress in the machine or tape longitudinal direction) but are lacking in clarity. On the other hand, tape made with sequentially oriented polypropylene film backings have been made which exhibit very good clarity, but are not as strong.

Prior attempts to form an oriented polymer film having relatively high tensile strength in the tape longitudinal direction with extremely high film clarity have not achieved an easily manufactured polypropylene film having such desired characteristics.

### BRIEF SUMMARY OF THE INVENTION

In one form, the present invention is a simultaneously biaxially oriented polypropylene film having a machine direction and a transverse direction, wherein the film comprises a propylene containing polymer resin. The film has a tensile strength in the machine direction of at least 190 N/mm², and the film has a normalized haze value of less than or equal to 8%/mm.

In another form, the present invention is an adhesive taped backing comprising a simultaneously biaxially stretched polypropylene film having a tape longitudinal direction and a tape width direction, wherein the film comprises a propylene containing polymer resin. The film has a tensile strength in the tape longitudinal direction of at least 190 N/mm², and the film has a normalized haze value of less than or equal to 8%/mm.

In another form, the present invention is an adhesive coated article comprising a simultaneously biaxially stretched polypropylene film and an adhesive coated layer on a first major surface of that film. The film has a tape longitudinal direction and a tape width direction, and comprises a propylene containing polymer resin. The film has a tensile strength in the tape longitudinal direction of at least 190 N/mm² and the film has a normalized haze value of less than or equal to 8%/mm.

In another form, the present invention is a roll of adhesive tape comprising a simultaneously biaxially stretched polypropylene film and an adhesive on a first major surface of that film. The film has a machine direction and a transverse direction, and comprises a propylene containing polymer resin. The film has a tensile strength in the machine direction of at least 190 N/mm², and the film has a normalized haze value of less than or equal to 8%/mm. The film is wound about an axis and upon itself in the machine direction, with the adhesive on the first major surface facing the axis.

In another form, the present invention is a biaxially stretched polypropylene film having a machine direction and a transverse direction, wherein the film comprises a propylene containing polymer resin. The stretched film has a tensile strength in the machine direction of at least 190 N/mm², a normalized haze value of less than or equal to 8%/mm, and a single azimuthal scan maximum within ±75° with respect to the machine direction, as measured by WAXS transmission azimuthal scan.

In another form, the present invention is an adhesive tape comprising a simultaneously biaxially stretched polypropylene film and an adhesive layer on a first major surface of the film. The film has a tape longitudinal direction and a tape width direction, and comprises a propylene containing polymer resin using a Ziegler-Natta catalyst. The film has a thickness of about 0.050 mm, a tensile strength in the tape longitudinal direction of at least 198 N/mm², and a normalized haze value of less than or equal to 6.4%/mm.

### BRIEF DESCRIPTION OF THE DRAWINGS

The present invention will be further explained with reference to the appended FIGS., wherein like structures referred to by like numerals through out the several view, and wherein:

FIG. 1 is an isometric view of a length of tape according to the present invention.

FIG. 2 is a side view of a roll of adhesive tape according to the present invention.

FIG. 3 is a schematic illustration of a film production processing system.

FIG. 4a is a representation of a sequentially stretched film.

FIG. 4b is a graphical representation of WAXS results for the film of FIG. 4a.

FIG. 5a is a presentation of a simultaneously stretched film.

FIG. 5b is a graphical representation of WAXS results for the film of FIG. 5a.

FIG. 6a is a representation of a MD biased simultaneously stretched film.

FIG. 6b is a graphical representation of WAXS results for the film of FIG. 6a.

FIG. 7a is a representation of a TD biased simultaneously stretched film.

FIG. 7b is a graphical representation of WAXS results for the film of FIG. 7a.

FIG. 8 is a chart comparing machine direction break stress and normalized haze, based on the films of Table 3.

While the above-identified figures set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art which fall within the scope and spirit of the principals of this invention. The figures may not be drawn to scale. Like reference numbers have been used throughout the figures to denote like parts.

### DETAILED DESCRIPTION

Certain terms are used in the description and the claims that, while for the most part are well known, may require some explanation. “Biaxially stretched,” when used herein to describe a film, indicates that the film has been stretched in two different directions, a first direction and a second direction, in the plane of the film. Typically, but not always, the two directions are substantially perpendicular and are in the longitudinal or machine direction (“MD”) of the film (the direction in which the film is produced on a film-making machine) and the transverse direction (“TD”) of the film (the direction perpendicular to the MD of the film). The MD is sometimes referred to as the Longitudinal Direction (“LD”). Biaxially stretched films may be sequentially stretched, simultaneously stretched, or stretched by some combination of simultaneous and sequential stretching. “Simultaneously biaxially stretched,” when used herein to describe a film, indicates that significant portions of the stretching in each of the two directions are performed simultaneously.

The term “stretch ratio,” as used herein to describe a method of stretching or a stretched film, indicates the ratio of a linear dimension of a given portion of a stretched film to the linear dimension of the same portion prior to stretching. For example, in a stretched film having an MD stretch ratio (“MDR”) of 5:1, a given portion of unstretched film having a 1 cm linear measurement in the machine direction would have 5 cm measurement in the machine direction after stretch. In a stretched film having a TD stretch ratio (“TDR”) of 9:1, a given portion of unstretched film having a 1 cm linear measurement in the transverse direction would have 9 cm measurement in the transverse direction after stretch.

“Area stretch ratio,” as used herein, indicates the ratio of the area of a given portion of a stretched film to the area of the same portion prior to stretching. For example, in a biaxially stretched film having an overall area stretch ratio of 50:1, a given 1 cm² portion of unstretched film would have an area of 50 cm² after stretching.

Unless context requires otherwise, the terms “orient,” “draw,” and “stretch” are used interchangeably throughout, as are the terms “oriented,” “drawn,” and “stretched,” and the terms “orienting,” “drawing,” and “stretching.”

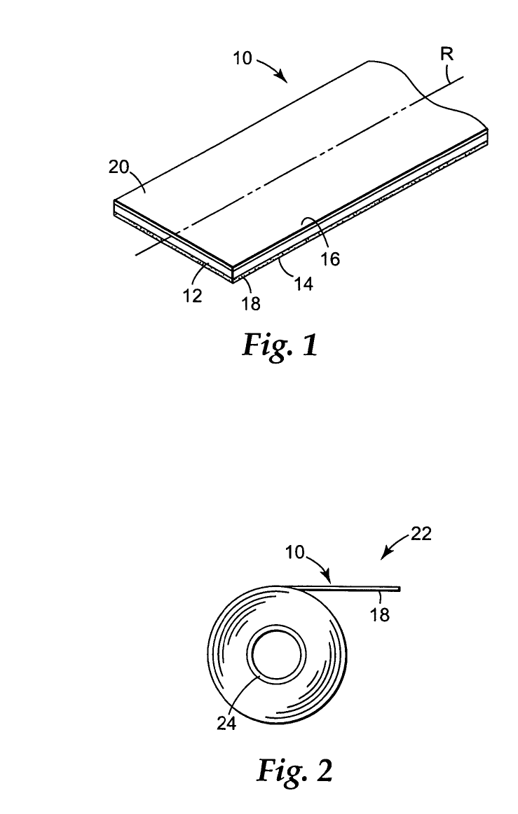

Referring to FIG. 1, there is shown a length of tape 10 according to one embodiment of the present invention. Tape 10 comprises a biaxially oriented film or film backing 12 which includes first major surface 14 and second major surface 16. Preferably, backing 12 has a thickness in the range of about 25 micrometers to 100 micrometers. Backing 12 of tape 10 may be coated on first major surface 14 with a layer of adhesive 18. Adhesive 18 may be any suitable adhesive as is known in the art. Backing 12 may have an optional release or low adhesion backsize layer 20 coated on the second major surface 16 as is known in the art.

The backing film 12 may comprise a single isotactic polypropylene, or a blend or mix of components such as two or more isotactic polypropylenes. Likewise, a second component comprising a polyolefin may comprise a single polyolefin or a mix or blend of two or more polyolefins.

For the purposes of the present invention, the term “polypropylene” is meant to include copolymers comprising at least about 90% propylene monomer units, by weight, polymerized by using catalyst systems. Preferably, the polymers or copolymers are polymerized by using catalyst systems other than metallocene-type catalysts, and more preferably, by using a Ziegler-Natta catalyst system. The polypropylene for use in the present invention is predominantly isotactic. Isotactic polypropylene has a chain isotacticity index of at least about 80%, an n-heptane soluble content of less than about 15% by weight, and a density between about 0.86 and 0.92 grams/cm³ measured according to ASTM D1505-96 (“Density of Plastics by the Density-Gradient Technique”). Typical polypropylenes for use in the present invention have a melt flow index between about 0.1 and 50 grams/10 minutes according to ASTM D1238-95 (“Flow Rates of Thermoplastics by Extrusion Plastometer”) at a temperature of 230° C. and force of 2160 g, a weight-average molecular weight between about 100,000 and 700,000 g/mole, and a polydispersity index between about 2 and 15. Typical polypropylenes for use in the present invention have a peak melting temperature as determined using differential scanning calorimetry of greater than about 140° C., preferably greater than about 150° C., and most preferably greater than about 160° C. Further, the polypropylenes useful in this invention may be copolymers, terpolymers, etc., having ethylene monomer units and/or alpha-olefin monomer units of between 4-8 carbon atoms, said comonomer(s) being present in an amount so as not to adversely affect the desired properties and characteristics of the backing and tapes described herein, typically their content being less than 10% by weight. One suitable polypropylene resin is an isotactic polypropylene homopolymer resin having a melt flow index of 2.5 g/10 minutes, commercially available under the product designation 3376 from AtoFina Petrochemicals, Inc., Houston, Tex. Another suitable polypropylene resin is an isotactic polypropylene homopolymer resin having a melt flow index of 9.0 g/10 minutes, commercially available under the product designation 3571, also from AtoFina Petrochemicals, Inc., Houston, Tex. The polypropylene resins are not restricted in terms of melt flow properties, as the proper melt flow resin may be chosen suitable for a particular polymer blend process and/or for a particular extrusion system.

Polypropylene for use in the present invention may optionally include, in an amount so as not to adversely affect the desired characteristics and properties described herein, a resin of synthetic or natural origin having a molecular weight between about 300 and 8000 g/mole, and having a softening point between about 60° C. and 180° C. Typically, such a resin is chosen from one of four main classes: petroleum resins, styrene resins, cyclopentadiene resins, and terpene resins. Optionally, resins from any of these classes may be partially or fully hydrogenated. Petroleum resins typically have, as monomeric constituents, styrene, methylstyrene, vinyltoluene, indene, methylindene, butadiene, isoprene, piperylene, and/or pentylene. Styrene resins typically have, as monomeric constituents, styrene, methylstyrene, vinyltoluene, and/or butadiene. Cyclopentadiene resins typically have, as monomeric constituents, cyclopentadiene and optionally other monomers. Terpene resins typically have, as monomeric constitutents, pinene, alpha-pinene, dipentene, limonene, myrcene, and camphene.

Polypropylene for use in the present invention may optionally include additives and other components as are known in the art. For example, the films of the present invention may contain fillers, pigments and other colorants, antiblocking agents, lubricants, plasticizers, processing aids, antistatic agents, nucleating agents, clarifiers, antioxidants and heat stabilizing agents, ultraviolet-light stabilizing agents, and other property modifiers. Fillers and other additives are preferably added in an effective amount selected so as not to adversely affect the desired clarity properties attained by the embodiments described herein. Typically such materials are added to a polymer before it is made into an oriented film (e.g., in the polymer melt before extrusion into a film).

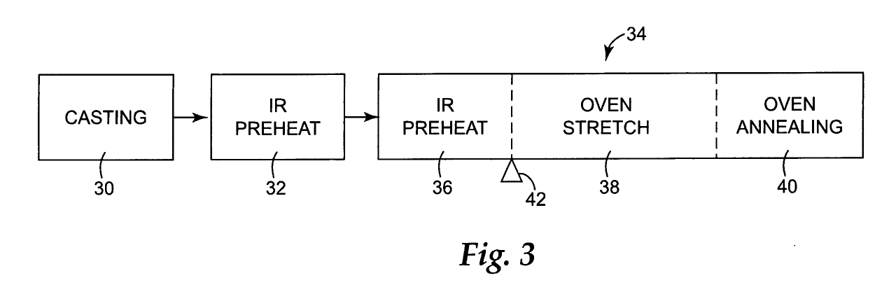

The isotactic polypropylene (and possible second blended polyolefin) can be cast into sheet form by apparatus known to those of skill in the art. Such cast films are then stretched to arrive at the preferred film described herein. FIG. 3 illustrates schematically a film production line which includes casting zone 30, preheat zone 32, and oven zone 34 through which the film travels during production. The oven zone 34 is further defined to include oven preheat zone 36, oven stretch zone 38 and oven annealing zone 40. When making films according to the present invention, a suitable method for casting a sheet (such as in casting zone 30) is to feed the resins into the feed hopper of a single screw, twin screw, cascade, or other extruder system having an extruder barrel temperature adjusted to produce a stable homogeneous melt. The melt can be extruded through a sheet die onto a rotating cooled metal casting wheel. Optionally, the casting wheel can be partially immersed in a fluid-filled cooling bath, or, also optionally, the cast sheet can be passed through a fluid-filled cooling bath after removal from the casting wheel. The temperatures of this operation can be chosen by those of skill in the art with the benefit of the teachings herein to provide the desired nucleation density, size, and growth rate such that the resulting stretched film has the desired characteristics and properties described herein. Typical casting wheel temperatures, as well as water bath temperatures, are below about 60° C., preferably below about 40° C., to provide a suitably crystallized sheet.

The cast sheet is then subjected to a specifically established preheating regime as described herein (e.g., as the film is advanced through preheat zone 32 and oven preheat zone 36), and then simultaneously biaxially stretched (e.g., in oven stretch zone 38) and annealed as stretched (e.g., in oven annealing zone 40) to provide film 12 having the desired characteristics and properties described herein.

The preferred properties described herein may be obtained by any suitable apparatus for biaxially orienting the film 12 according to the methods described herein. Of all stretching methods, the apparatus preferred for commercial manufacture of the inventive film for use as a tape backing includes the tenter apparatus for simultaneous biaxial stretch disclosed in U.S. Pat. Nos. 4,675,582; 4,825,111; 4,853,602; 5,036,262; 5,051,225; and 5,072,493. Although biaxially stretched films can be made by tubular blown film or bubble film making processes, it is preferable that the films of this invention, when used as tape backings, be made by a flat film stretching apparatus to avoid processing difficulties such as non-uniform thickness and stretching, and inadequate temperature control that may arise with tubular blown film processes.

In one preferred embodiment, the biaxial area stretch ratio is above about 36:1, more preferably from about 36:1 to about 90:1, still more preferably about 45:1 to about 90:1, and most preferably from about 55:1 to about 90:1. The upper limit for area stretch ratio is the practical limit at which the film can no longer be stretched on commercial available apparatus at sufficiently high speeds. Preferably, the MD stretch ratio is above about 4:1, more preferably from about 4:1 to about 8.5:1, still more preferably from about 5:1 to about 8:5:1, and most preferably from about 6.0:1 to about 8.5:1. The MD component and TD component of these embodiments is chosen so as to provide the desired film properties and characteristics described herein. If the orientation of the films of this invention are below the stated ranges, the film tends to be understretched, which can lead to localized necking and non-uniformity of thickness and physical properties across the sheet, both of which are highly undesirable from the standpoint of adhesive tape manufacturing. In addition, inadequate stretching can adversely affect the desired film clarity and strength of the film.

In one preferred embodiment, the machine direction stretch ratio is at about the same as or greater than the transverse direction stretch ratio, to provide adhesive tape backing film with the desired film clarity and with the desired tensile strength in the machine direction. In other words, the stretch ratio in the tape width direction is about the same as the stretch ratio in the tape longitudinal direction, for a tape which is distributed in a longitudinal orientation such as in elongated strips or from a roll.

With respect to preheating of the cast film prior to stretching, superior final film clarity has been attained by precisely controlling preheating temperature set points, while also attaining high tensile strengths in the final film, in the machine direction. In the film production system illustrated in FIG. 3, the film is exposed to an infrared heating zone 32 after casting, and then to an oven preheat zone 36. For example, for the polypropylene homopolymer identified as product designation 3376 from AtoFina Petrochemicals, Inc., Houston, Tex. (which has a melting point (DSC) of 161.5° C.), a heating regime which attains a film surface temperature of about 153° C. or less at the initiation of stretching (as at temperature probe 42 in FIG. 3 (e.g., a pyrometer)) resulted in a film having a combination of superior strength and very good clarity. A film surface temperature ranging from about 149° C. to about 153° C. was found to be effective to gain the desired final film attributes, at least for a 0.050 mm thick stretched film material of the 3376 AtoFina resin, with a film surface temperature ranging from about 150° C. to about 152° C. being even more preferred for such conditions. For a random copolymer identified as product designation 6253 from AtoFina (which has a melting point (DSC) of 146.2° C.), a heating regime which attains a film surface temperature of about 141.8° C. at the initiation of stretching resulted in a film having improved strength and good clarity. As these examples illustrate, as the melting point of the polymer resin is reduced, a reduction in the film pre-stretch preheat temperature regime results in a final film having the desired tensile strength and clarity properties (for most polyolefins, it is expected that a temperature differential of from 7° to 15° C. will suffice). For a particular production system and material, a characteristic break stress/preheat pyrometer temperature curve may exist. The break stress/preheat pyrometer temperature curve is dependent on the melting point of the polymer. As preheat temperature is reduced, the pyrometer temperature measured at the inlet of the stretching zone (as at pyrometer probe 42) also drops. As the infrared pyrometer temperature drops, the clarity of the film is improved while the break stress is increased.

The temperatures of the stretching operation (i.e., in oven stretch zone 38) can be chosen by those of skill in the art with the benefit of the teachings herein to provide a film having the desired characteristics and properties described herein. These temperatures will vary with the material used, and with the heat transfer characteristics of the particular apparatus used.

The film backing 12 useful in this invention, when used as a backing for a tape 10, preferably has a final thickness between about 25 micrometers to 100 micrometers. Variability in film thickness is preferably less than about 5%. Thicker and thinner films may be used, with the understanding that the film should be thick enough to avoid excessive flimsiness and difficulty in handling, while not being so thick so as to be undesirably rigid or stiff and difficult to handle or use.

The polypropylene composition, extrusion temperature, cast roll temperature, and stretch temperature and other parameters are selected in accordance with the teachings herein such that the resulting film backing or tape has the following preferred properties, taken individually or in any preferred combination.

A. A tensile strength in the machine direction of at least 190 N/mm², more preferably 200 N/mm², and even more preferably 210 N/mm².

B. A normalized haze value of less than or equal to 8%/mm, more preferably 7%/mm, and even more preferably 6%/mm.

With respect to factor A above, the preferred values are described with respect to the film tensile property determination tests outlined below. With respect to factor B above, the normalized haze value is established by the haze test method set forth below.

Tensile strength in the longitudinal direction of a film (and particularly the adhesive tape which is dispensed longitudinally) is important for film strength and use. Measurements of film clarity are conducted using haze evaluations or percent transmission of white light evaluations through one or more layers of a film or through an established film thickness. A lower haze value equates to better clarity. A typical roll of adhesive tape made with 0.050 mm film backing is wound on a three inch diameter (9.62 cm) roll core, and may be 50 meters long. This means there are about 180 layers of film from the outer surface of a full roll to the outer surface of the core. An improvement in percent haze/mm of about 2% for each mm thickness of film becomes about an 18% reduction in haze in a 50 meter roll of tape. Hence, the difference is quite noticeable.

The above properties and characteristics are described herein with respect to the preferred embodiments, and reported herein with respect to the examples, for a film or film backing 12 without adhesive 18 thereon. It is expected that in most cases, the characteristics and properties are governed primarily by the backing, with little affect by the adhesive or other layers or coatings. Therefore, the above preferred characteristics and properties also apply to the adhesive tapes of the present invention.

There are several widely accepted means by which to measure molecular orientation in oriented polymer systems, among them scattering of light or X-ray, absorbance measurements, mechanical property analysis, and the like. Quantitative methods include wide angle X-ray scattering (“WAXS”), optical birefringence, infrared dichroism, and small angle X-ray scattering (“SAXS”). A preferred method to determine the crystalline chain axis orientation distribution is the WAXS technique, in which crystalline planes within the fibrillar structures scatter or diffract incident X-ray beams at an established angle, known as the Bragg angle (see A. W. Wilchinsky, Journal of Applied Physics, 31(11), 1969 (1960) and W. B. Lee et al., Journal of Materials Engineering and Performance, 5(5), 637 (1996)). In WAXS, a crystalline plane, for example the monoclinic (110) plane of isotactic polypropylene containing information about the polypropylene molecular chain (or c-) axis is measured and then related by sample geometry to external co-ordinates.

The inventive films preferably have a specific, single crystalline morphology orientation with respect to either the machine direction or a reference direction “R” (see FIG. 1).

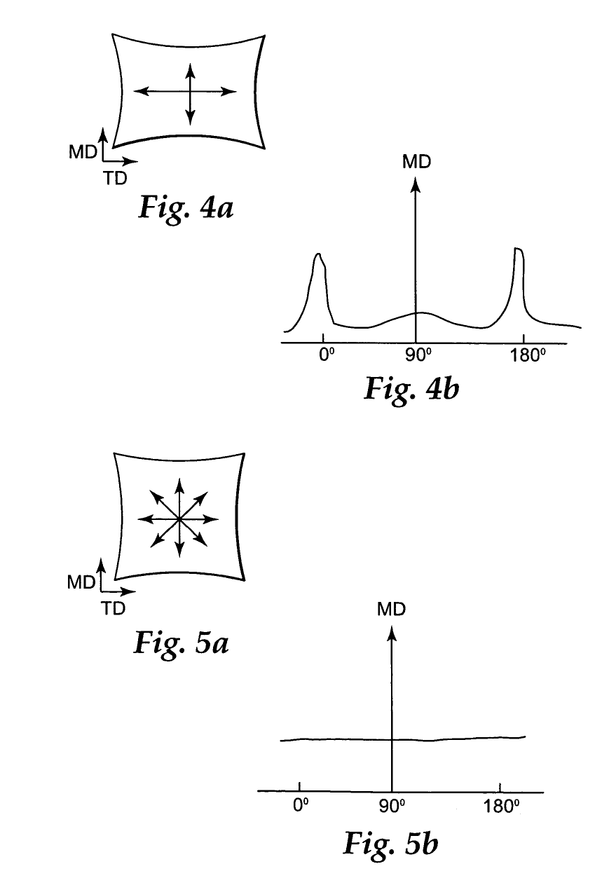

Referring specifically to FIGS. 4a to 7b, FIGS. 4a, 5a, 6a, and 7a are representations of the orientation condition in stretched films. The specific order and orientation are set forth below. FIGS. 4b, 5b, 6b and 7b are graphical representation of WAXS results at various values of the stretched films shown in FIGS. 4a, 5a, 6a, and 7a, respectively.

The “reference direction” as used herein, is the axis lying in the plane of the film against which the crystalline orientation is defined. When determining the mechanical properties of a film, the reference direction is the direction in which the film is stretched. For backing films converted into adhesive tape in roll form, the reference direction is the direction in which the stock roll is slit into narrow width to be wound into tape rolls. Typically, though not always, the reference direction is the same as the longitudinal or machine direction (MD) of the film.

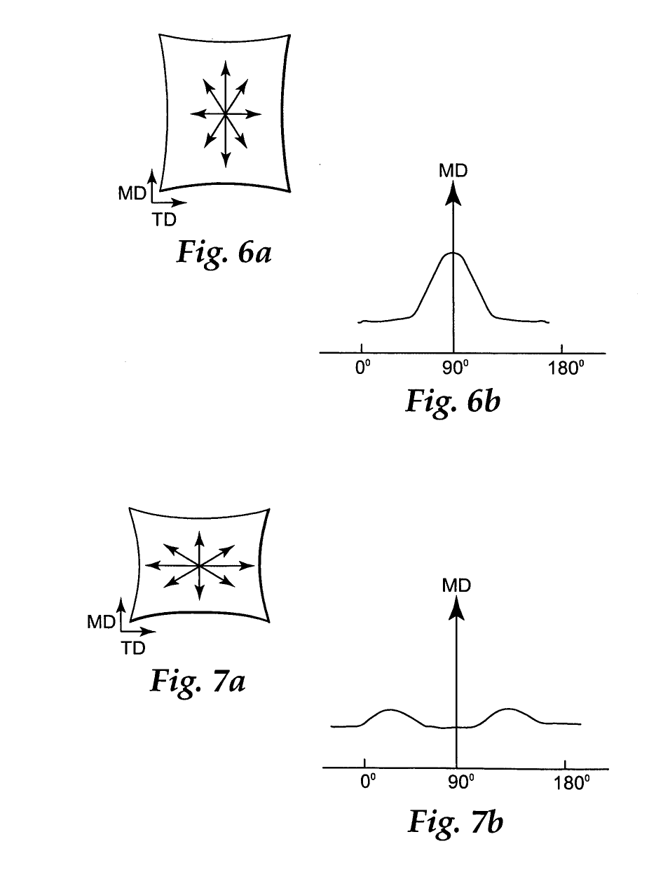

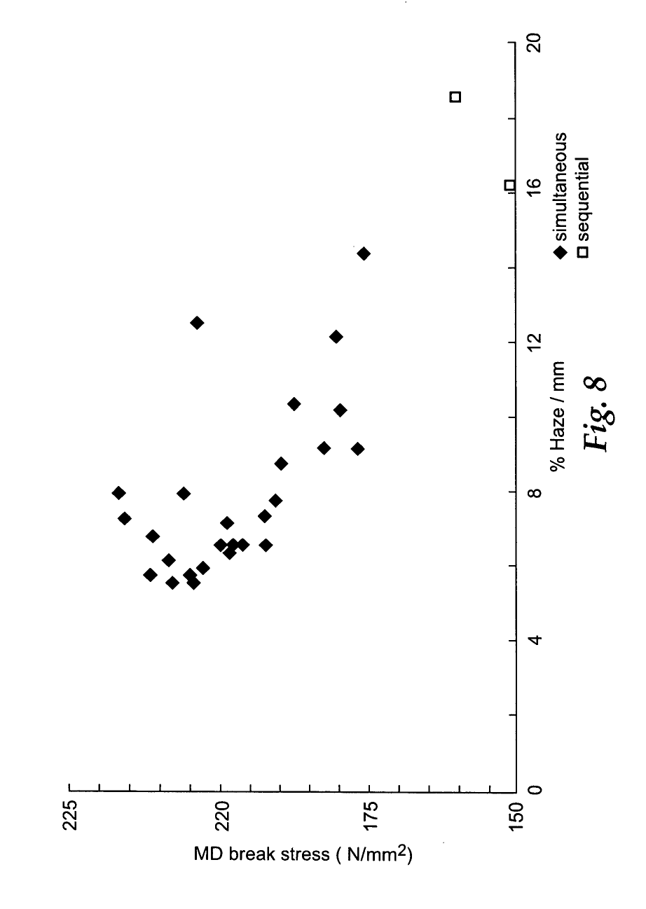

A particularly useful characteristic indicating the balanced simultaneous stretching of the inventive films is that they exhibit a crystalline orientation as determined by wide angle X-ray scattering measurements from the monoclinic (110) crystalline planes that is isotropic or has a single azimuthal scan maximum, said single azimuthal scan maximum being positioned at an angle of up to +75′ relative to a reference direction. The diffraction patterns referred to are those detected by examination of one quadrant of a typical WAXS diffraction pattern, for example the azimuthal angular range from 90° to 180°. Although the FIGS. 4b to 7b depict the diffraction pattern between the angles of 0° and 180°, it is the case that the region from 0° to 90° is a mirror image of that from 90° to 180°. The choice of depicting data from 0° to 180° is made to allow diffraction patterns centered about 90° angles, that is, the MD to be more clearly descerned. The single azimuthal scan maximum in addition possesses an angular full width at half peak height between about 40° to 75°, as shown in FIGS. 6a and 6b. If the inventive films possess an isotropic crystalline orientation distribution, then the WAXS azimuthal scan does not exhibit a distinct maximum, as shown in FIGS. 5a and 5b. In this case the crystalline chain axis orientation is evenly distributed in the plane of the film.

By contrast, the occurrence of two or more WAXS azimuthal scan maxima, as shown in FIG. 4b, at least one of which is positioned at an angle of greater than about ±75′ relative to said reference direction or a single, specific WAXS azimuthal scan maximum which is positioned at an angle of greater than about ±750 relative to said reference direction, is characteristic of an undesirably oriented film.

A “single maximum” when used to describe the WAXS azimuthal scan of the inventive films disclosed herein will be identifiable as a single inflection observed from a WAXS transmission azimuthal scan, exhibiting symmetry within the 360° angular range probed by the X-ray scans due to the diffractometer geometry and the crystal physics of the monoclinic isotactic polypropylene. Such a single maximum is distinguishable from noise in the data and the scattered intensity due to portions of the polymer matrix possessing random orientation, that will typically have a magnitude of less than 1% of the maximum value. Examples of measurement techniques for WAXS azimuthal scan values are described in U.S. Pat. No. 6,638,637, which is incorporated herein.

The adhesive 18 coated on the first major surface 14 of film backing 12 may be any suitable adhesive as is known in the art. Preferred adhesives are those activatable by pressure, heat or combinations thereof. Suitable adhesives include those based on acrylate, rubber resin, epoxies, urethanes or combinations thereof. The adhesive 18 may be applied by solution, water-based or hot-melt coating methods. The adhesive can include hot melt-coated formulations, transfer-coated formulations, solvent-coated formulations, and latex formulations, as well as laminating, thermally-activated, and water-activated adhesives. Useful adhesives according to the present invention include all pressure sensitive adhesives. Pressure sensitive adhesives are well known to possess properties including: aggressive and permanent tack, adherence with no more than finger pressure, and sufficient ability to hold onto an adherend. Examples of adhesives useful in the invention include those based on general compositions of polyacrylate; polyvinyl ether; diene rubber such as natural rubber, polyisoprene, and polybutadiene; polyisobutylene; polychloroprene; butyl rubber; butadiene-acrylonitrile polymer; thermoplastic elastomer; block copolymers such as styrene-isoprene and styrene-isoprene-styrene (SIS) block copolymers, ethylene-propylene-diene polymers, and styrene-butadiene polymers; poly-alpha-olefin; amorphous polyolefin; silicone; ethylene-containing copolymer such as ethylene vinyl acetate, ethylacrylate, and ethyl methacrylate; polyurethane; polyamide; epoxy; polyvinylpyrrolidone and vinylpyrrolidone copolymers; polyesters; and mixtures or blends (continuous or discontinuous phases) of the above. Additionally, the adhesives can contain additives such as tackifiers, plasticizers, fillers, antioxidants, stabilizers, pigments, diffusing materials, curatives, fibers, filaments, and solvents. Also, the adhesive optionally can be cured by any known method.

A general description of useful pressure sensitive adhesives may be found in Encyclopedia of Polymer Science and Engineering, Vol. 13, Wiley-Interscience Publishers (New York, 1988). Additional description of useful pressure sensitive adhesives may be found in Encyclopedia of Polymer Science and Technology, Vol. 1, Interscience Publishers (New York, 1964).

The film backing 12 of the tape 10 may optionally be treated by exposure to flame or corona discharge or other surface treatments including chemical priming to improve adhesion of subsequent coating layers. In addition, the second surface 16 of the film backing 12 may be coated with optional low adhesion backsize materials 20 to restrict adhesion between the opposite surface adhesive layer 18 and the film 12, thereby allowing for production of adhesive tape rolls capable of easy unwinding, as is well known in the adhesive coated tape-making art. The tape 10 may be spirally wound to make a roll 22, optionally on core 24, as illustrated in FIG. 2.

The film backings described herein are well-suited for many adhesive tape backing applications, including utility tapes, light duty tapes, and sealing and mending tapes. Because the backing is conformable, it is also useful as a masking tape backing.

Film Tensile Property Determinations

The machine direction (MD) tensile strength-at-break was measured according to the procedures described in ASTM D882-97, “Tensile Properties of Thin Plastic Sheeting,” Method A. The films were conditioned for 24 hours at 22° C. (72° F.) and 50 percent relative humidity (RH) prior to testing. The tests were performed using a tensile testing machine commercially available as a Model No. Sintech 200/S from MTS Systems Corporation, Eden Prairie, Minn. Specimens for this test were 2.54 cm wide and 15 cm long. An initial jaw separation of 10.2 cm and a crosshead speed of 25.4 cm/min were used. At least four specimens were tested for each sample in the MD.

Haze Test Method

The haze of example films was measured according to ASTM D1003-00. The hazemeter used in the measurement was a Haze-gard plus, Cat. No. 4725 available from BYK-Gardner USA of Columbia, Md. Sample specimens 15 cm by 15 cm in size were cut from film sheets so that no oil, dirt, dust or fingerprints were present in the section to be measured. The specimens were then mounted by hand across the haze port of the hazemeter and the measurement activated. Five replicate % haze measurements were taken, and the average of these five measurements reported as the % haze value herein.

The % haze measurements were also normalized by dividing the % haze values by the respective thickness for each example. For example, the normalized % haze of Example 1 (Table 3) is derived as follows:
% haze=0.30%, thickness of 1 layer=0.050 mm,
normalized value: % haze per mm=0.30%/0.050 mm=6.0%/mm.
   Melting Point Determination

The melting points of resin samples were determined according to ASTM E794-98, using a DuPont Model 2100 Differential Scanning Calorimeter (DSC) with a heating rate of 10° C./min through the temperature range from 25° to 200° C. Approximately 5 mg of resin sample were loaded into metal DSC pans, crimped, and set into the test chamber. Samples were first heated under positive nitrogen pressure at 10° C./min from 25° to 200° C., held at 200° C. for 3 minutes, cooled at 10° C./min to 25° C., then re-scanned in order to ensure good contact between the sample and the DSC pan, the endothermic peak of the second scan was taken as the melting point of the polymer samples. Values are reported in Table 1.

The operation of the present invention will be further described with regard to the following detailed examples. These examples are offered to further illustrate the various specific and preferred embodiments and techniques. It should be understood, however, that many variations and modifications may be made while remaining within the scope of the present invention.

### PREPARATION OF EXAMPLES

A) Linear Motor Simultaneous Stretching Process

Simultaneously biaxially oriented polypropylene examples 1 to 27 were prepared using the linear motor based simultaneous stretching process described in U.S. Pat. Nos. 4,675,582; 4,825,111; 4,853,602; 5,036,262; 5,051,225; and 5,072,493. The stretching equipment was built by Brückner Maschinenbraü, Seigsdorf, Germany. Polymer A, described in Table 1, was used in examples 1 to 27.

In Example 1, a single screw extrusion system was used to provide a stable melt having a melt temperature of about 227 to 258° C. The polymer melt was extruded through a slot die and cast onto a water-cooled chrome-plated steel casting wheel rotating at about 17.2 meters per minute and which was controlled to about 35° C. using closed loop internal water circulation and by immersing the casting wheel in a water bath, the water being about 17.2-22° C. The cast sheet had a width of about 86 cm and a thickness of about 0.26 cm. For examples that were 0.035 mm in thickness and run at 145 m/min, the casting wheel rotated at about 21 meters per minute. For examples that were 0.035 mm in thickness and run at 180 m/min, the casting wheel rotated at about 25 to 26 meters per minute. For examples that were 0.030 mm in thickness and run at 209 m/min, the casting wheel rotated at about 29 to 30 meters per minute. Cast film thicknesses of the films that were stretched to 0.035 and 0.030 mm were thus adjusted so as to provide the final thickness when drawn at the MDR and TDR draw ratios listed in Table 2.

In example 1, the cast sheet was passed through a bank of IR heaters set to about 450° C. to preheat the cast film to approximately 88° C., (70-72° C. for the 0.030 mm films, and about 76 to 81° C. for the 0.035 mm films) as measured by IR surface pyrometry, prior to simultaneous stretching in the tenter oven. The cast and preheated film was immediately further preheated in the oven, and then simultaneously stretched in longitudinal (MD) and transverse (TD) directions to produce biaxially oriented film. For example 1, the preheat section of the oven was adjusted to provide a preheated film with a temperature of about 149.5 C, as measured by IR surface pyrometry. The IR pyrometer used was a Heitronics model KT15.21D. For the other examples, the film surface temperatures in the preheat section of the oven, at the initiation of stretching, as measured by the IR pyrometer (e.g., pyrometer 42 in FIG. 3), are listed in Table 2.

The oven temperature setpoints used during the stretching and annealing sections of the tenter for each example are listed in Table 2. The final total area stretching ratio was about 43.4 to 1. The MD ratio was about 7.0/1 and the TD ratio was about 6.2/1 for each example made with this process. Values for all of the examples are listed in Table 2. The stretched film of example 1 was about 0.050 mm thick and the width was about 536 cm. Wind-up speed was about 120 meters/minute. The film was slit (offline) in the machine direction into useful sample widths for testing using a razor blade cutter equipped with fresh blades. The film properties are shown in Table 3.

Differences in processing conditions, compared with Example 1, for the other examples, are listed in Table 2 as well as being described above. Corresponding film properties for the example films are shown in Table 3.

B) Sequential Stretching Process

Comparative example 28 was prepared as follows. Polymer B, from Table 1, was fed to an extrusion system consisting of single screw extruders to produce a stable melt having a melt temperature of between 251 to 268° C. The melt was extruded through a slot die and cast onto a water-cooled chrome-plated steel casting wheel rotating at about 19.3 meters per minute and which was controlled to about 44° C. using closed loop internal water circulation and by immersing the casting wheel in a water bath, the water being about 19.8° C. The cast sheet had a width of about 90 cm and a thickness of about 0.23 cm.

The cast film was passed over a set of rollers internally heated to temperatures of about 125° C. to 149° C. and stretched in the longitudinal or machine direction (MD) to a stretch ratio of about 5.4:1, between rollers rotating from about 20 meters per minute to 108 meters per minute. The MD stretched sheet, about 81.5 cm in width and about 0.045 to 0.050 cm in thickness, was next gripped edgewise in a series of clips on tenter rails which diverged in a stretching zone, and stretched in the crosswise or transverse direction (TD). The final TD stretch ratio was about 8.5:1. The preheat zone setpoints were set to about 178° C. Specific stretching and annealing zone temperature setpoint conditions for example 28 are listed in Table 2. The resulting sequentially biaxially stretched film was cooled to room temperature, its edges trimmed by razor slitting and wound onto a master roll at about 109 meters per minute. The stretched film of comparative example 28 was about 0.050 mm thick and the width was about 660 cm. The film was slit (offline) in the machine direction into useful sample widths for testing using a razor blade cutter equipped with fresh blades. The film properties are shown in Table 3.

Comparative example 29 was also made with this process. The melt was extruded through a slot die and cast onto a water-cooled chrome-plated steel casting wheel rotating at about 28.6 meters per minute and which was controlled to about 36° C. using closed loop internal water circulation and by immersing the casting wheel in a water bath, the water being about 20° C. The cast sheet had a width of about 90 cm and a thickness of about 0.13 cm.

The cast film was passed over a set of rollers internally heated to temperatures of about 125° C. to 149° C. and stretched in the longitudinal or machine direction (MD) to a stretch ratio of about 5.4:1, between rollers running from about 20 meters per minute to 108 meters per minute. The MD stretched sheet, about 81.5 cm in width and about 0.025 to 0.030 cm in thickness, was next gripped edgewise in a series of clips on tenter rails which diverged in a stretching zone, and stretched in the crosswise or transverse direction (TD). The final TD stretch ratio was about 8.5:1. The preheat zone setpoints were set to about 165° C. Specific stretching and annealing zone temperature setpoint conditions for example 29 are listed in Table 2. The resulting sequentially biaxially stretched film was cooled to room temperature, its edges trimmed by razor slitting and wound onto a master roll at about 158 meters per minute. The stretched film of comparative example 29 was about 0.035 mm thick and the width was about 660 cm. The film was slit (offline) in the machine direction into useful sample widths for testing using a razor blade cutter equipped with fresh blades. Corresponding film properties are shown in Table 3.

TABLE 1
POLYMER IDENTIFICATION

| | | | | | | Tm (DSC) |
|---|---|---|---|---|---|---|
| Polymer | General description | Supplier | Designation | MFR¹ | % ethylene | (° C.) |
| A | PP homopolymer | Atofina² | PP 3376 | 2.5 | 0 | 161.5 |
| B | PP random | Exxon³ | Escorene | 2.8 | 0.5 | 158.4. |
| | copolymer | | 4792-E1 | | | |

¹Reported in g/10 min as determined by ASTM D1238 −95: MFR at 230° C., 2.16 kg condition. The MFR and % ethylene values were provided by the manufacturers.
²AtoFina Petrochemicals, Inc., Houston, Texas
³Exxon Mobil Corporation, Irving, Texas

TABLE 2
STRETCHING CONDITIONS

| | | | | | Film | | |
|---|---|---|---|---|---|---|---|
| | | Wind Up | | | Temperature | | |
| | | Rate | | | IR pyrometer | Stretch | Anneal |
| EX | Process | (m/min) | MDR | TDR | (° C.) | (° C.) | (° C.) |
| 1 | A | 120 | 7.0 | 6.2 | 149.5 | 155 | 145 |
| 2 | A | 120 | 7.0 | 6.2 | 150.2 | 155 | 145 |
| 3 | A | 120 | 7.0 | 6.2 | 150.3 | 155 | 145 |
| 4 | A | 120 | 7.0 | 6.2 | 151.0 | 155 | 145 |
| 5 | A | 120 | 7.0 | 6.2 | 152.1 | 155 | 145 |
| 6 | A | 120 | 7.0 | 6.2 | 152.5 | 158 | 145 |
| 7 | A | 120 | 7.0 | 6.2 | 152.5 | 155 | 145 |
| 8 | A | 120 | 7.0 | 6.2 | 152.9 | 155 | 145 |
| 9 | A | 120 | 7.0 | 6.2 | 153.0 | 155 | 145 |
| 10 | A | 120 | 7.0 | 6.2 | 153.2 | 155 | 145 |
| 11 | A | 120 | 7.0 | 6.2 | 153.3 | 155 | 145 |
| 12 | A | 120 | 7.0 | 6.2 | 153.6 | 155 | 145 |
| 13 | A | 120 | 7.0 | 6.2 | 153.6 | 155 | 145 |
| 14 | A | 120 | 7.0 | 6.2 | 154.4 | 155 | 145 |
| 15 | A | 120 | 7.0 | 6.2 | 154.5 | 155 | 145 |
| 16 | A | 180 | 7.0 | 6.2 | 151.7 | 155 | 145 |
| 17 | A | 145 | 7.0 | 6.2 | 150.8 | 155 | 145 |
| 18 | A | 209 | 7.0 | 6.2 | 151.3 | 155 | 145 |
| 19 | A | 209 | 7.0 | 6.2 | 151.4 | 155 | 145 |
| 20 | A | 120 | 7.0 | 6.2 | 155.0 | 155 | 145 |
| 21 | A | 120 | 7.0 | 6.2 | 155.0 | 158 | 145 |
| 22 | A | 120 | 7.0 | 6.2 | 155.1 | 155 | 145 |
| 23 | A | 120 | 7.0 | 6.2 | 155.2 | 155 | 145 |
| 24 | A | 120 | 7.0 | 6.2 | 155.2 | 155 | 145 |
| 25 | A | 120 | 7.0 | 6.2 | 155.3 | 155 | 145 |
| 26 | A | 120 | 7.0 | 6.2 | 155.8 | 155 | 145 |
| 27 | A | 145 | 7.0 | 6.2 | 152.6 | 155 | 145 |
| 28 | B | 109 | 5.4 | 8.5 | — | 158 | 163 |
| 29 | B | 158 | 5.4 | 8.5 | — | 158 | 160 |

TABLE 3
FILM PROPERTIES

| | | MD Tensile | | Normalized % |
|---|---|---|---|---|
| | Thickness | Break Stress | ASTM 1003-00 | Haze |
| Example | (mm) | (N/mm²) | % Haze | (%/mm) |
| 1 | 0.050 | 203 | 0.30 | 6.0 |
| 2 | 0.050 | 208 | 0.31 | 6.2 |
| 3 | 0.050 | 204 | 0.28 | 5.6 |
| 4 | 0.050 | 211 | 0.29 | 5.8 |
| 5 | 0.050 | 198 | 0.32 | 6.4 |
| 6 | 0.050 | 205 | 0.29 | 5.8 |
| 7 | 0.050 | 208 | 0.28 | 5.6 |
| 8 | 0.050 | 198 | 0.33 | 6.6 |
| 9 | 0.050 | 198 | 0.32 | 6.4 |
| 10 | 0.050 | 192 | 0.33 | 6.6 |
| 11 | 0.050 | 200 | 0.33 | 6.6 |
| 12 | 0.050 | 196 | 0.33 | 6.6 |
| 13 | 0.050 | 199 | 0.36 | 7.2 |
| 14 | 0.050 | 192 | 0.37 | 7.4 |
| 15 | 0.050 | 190 | 0.39 | 7.8 |
| 16 | 0.035 | 211 | 0.24 | 6.9 |
| 17 | 0.035 | 217 | 0.28 | 8.0 |
| 18 | 0.030 | 216 | 0.22 | 7.3 |
| 19 | 0.030 | 206 | 0.24 | 8.0 |
| 20 | 0.050 | 182 | 0.46 | 9.2 |
| 21 | 0.050 | 179 | 0.51 | 10.2 |
| 22 | 0.050 | 177 | 0.46 | 9.2 |
| 23 | 0.050 | 189 | 0.44 | 8.8 |
| 24 | 0.050 | 180 | 0.61 | 12.2 |
| 25 | 0.050 | 187 | 0.52 | 10.4 |
| 26 | 0.050 | 175 | 0.72 | 14.4 |
| 27 | 0.035 | 203 | 0.44 | 12.5 |
| 28 | 0.050 | 151 | 0.81 | 16.2 |
| 29 | 0.035 | 160 | 0.65 | 18.6 |

The tests and test results described above are intended solely to be illustrative, rather than predictive, and variations in the testing procedure can be expected to yield different results.

The present invention has now been described with reference to several embodiments thereof. The foregoing detailed description and examples have been given for clarity of understanding only. No unnecessary limitations are to be understood therefrom. All patents and patent applications cited herein are hereby incorporated by therefrom. All be apparent to those skilled in the art that many changes can be made in reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

1. A simultaneously biaxially oriented polypropylene film having a machine direction and a transverse direction, wherein the film comprises a propylene containing polymer resin, the film having a tensile strength in the machine direction of at least 190 N/mm² and the film having a normalized haze value of less than or equal to 8%/mm.

2. The film of claim 1 wherein the film has a tensile strength in the machine direction of at least 200 N/mm².

3. The film of claim 2 wherein the film has a tensile strength in the machine direction of at least 210 N/mm².

4. The film of claim 1 wherein the film has a normalized haze value of less than or equal to 7%/mm.

5. The film of claim 4 wherein the film has a normalized haze value of less than or equal to 6%/mm.

6. The film of claim 1 wherein the resin is substantially free from metallocene catalyst.

7. The film of claim 6 wherein the resin is a propylene containing polymer produced using a Ziegler-Natta catalyst.

8. The film of claim 1 wherein the ratio of the machine direction stretch ratio to the transverse direction stretch ratio is approximately 1:1.

9. The film of claim 1 wherein a single azimuthal scan maximum of the stretched film is within ±75° with respect to the machine direction, as measured by WAXS transmission azimuthal scan.

10. An adhesive tape backing comprising a simultaneously biaxially stretched polypropylene film having a tape longitudinal direction and a tape width direction, wherein the film comprises a propylene containing polymer resin, the film having a tensile strength in the tape longitudinal direction of at least 190 N/mm² and the film having a normalized haze value of less than or equal to 8%/mm.

11. An adhesive coated article comprising:
(a) a simultaneously biaxially stretched polypropylene film having a tape longitudinal direction and a tape width direction, wherein the film comprises a propylene containing polymer resin, the film having a tensile strength in the tape longitudinal direction of at least 190 N/mm² and the film having a normalized haze value of less than or equal to 8%/mm; and
(b) an adhesive coated layer on a first major surface of the film.

12. A roll of adhesive tape comprising:
(a) a simultaneously biaxially stretched polypropylene film having a machine direction and a transverse direction, wherein the film comprises a propylene containing polymer resin, the film having a tensile strength in the machine direction of at least 190 N/mm² and the film having a normalized haze value of less than or equal to 8%/mm; and
(b) an adhesive on a first major surface of the film, wherein the film is wound about an axis and upon itself in the machine direction, with the adhesive on the first major surface facing the axis.

13. A biaxially stretched polypropylene film having a machine direction and a transverse direction, wherein the film comprises a propylene containing polymer resin, the stretched film having a tensile strength in the machine direction of at least 190 N/mm², a normalized haze value of less than or equal to 8%/mm, and a single azimuthal scan maximum within +75° with respect to the machine direction, as measured by WAXS transmission azimuthal scan.

14. An adhesive tape comprising:
(a) a simultaneously biaxially stretched polypropylene film having a tape longitudinal direction and a tape width direction, wherein the film comprises a propylene containing polymer resin using a Ziegler-Natta catalyst, the film having a thickness of about 0.050 mm, a tensile strength in the tape longitudinal direction of at least 198 N/mm², and a normalized haze value of less than or equal to 6.4%/mm; and
(b) an adhesive layer on a first major surface of the film.
